(19) United States
(12) Patent Application Publication
(10) Pub. No.: US 2011/0233929 A1
(43) Pub. Date: Sep. 29, 2011

(54) ROTATABLE FLANGE Y-STRAINER

(75) Inventor: Jason Lars Olsen, Wellesley, MA (US)

(73) Assignee: WEBSTONE COMPANY, INC., Worcester, MA (US)

(21) Appl. No.: 12/851,957

(22) Filed: Aug. 6, 2010

Related U.S. Application Data
(63) Continuation-in-part of application No. 12/749,020, filed on Mar. 29, 2010.

(51) Int. Cl. F16L 23/00

(52) U.S. Cl. 285/406

(57) ABSTRACT

A rotatable flange structure is provided which is integrally or monolithically formed with a Y-strainer. The rotatable flange structure can be installed over the front-mating surface of the Y-strainer. A retaining ring fits inside the grooves on the outer edge of a flange portion and on the inner edge of a mounting plate to keep the mounting plate attached to the flange portion. The flange portion can be assembled to the mounting plate and can be removed from the mounting plate in only one direction. The mounting plate may be prevented from completely being removed from the Y-strainer by an angular branch of the Y-strainer body. The retaining ring is compressed slightly by the flange portion as the rotatable mounting plate is installed to the flange portion and snaps back out into the mounting plate groove to complete the assembly and retain the mounting plate to the flange portion.

### CROSS REFERENCE TO RELATED APPLICATIONS

This application is a continuation in part (CIP) of U.S. patent application Ser. No. 12/749,020, filed on Mar. 29, 2010, the contents of which are incorporated herein by reference in their entirety.

### BACKGROUND

The present invention relates generally to flanges and more particularly to flanges for connecting plumbing and heating components.

Flanges are well known structures used to provide mating surfaces on plumbing and heating components for interconnection there-between. Typical flanges include surfaces which fit against similar mating surfaces on other components to provide a fluid seal in the connection. Flanges also typically include mounting portions that provide for fasteners such as holes for accepting studs or bolts which are used to securely connect the flange to a mating flange or mating surface.

Typical plumbing and heating components such as pipes and valves are provided with a flange that is fixedly formed with portions of the component body or main structure. For example, a typical heating system valve may include a flange portion that is monolithically formed with the valve body. Such fixedly formed flange portions can make mounting in certain orientations or positions difficult or impossible due to interferences with other fixedly mounted apparatuses and structures.

Simple collar type mounting structures are not suitable to provide a rotatable flange in most plumbing and heating components because any such collar structure generally needs to be mounted from the back side of the plumbing or heating component. Collars that are large enough to be installed to a plumbing or heating component from the front side, e.g. over the mating surface, can not be used to retain an interconnection between mating surfaces because they would not provide the necessary overlap with the mating surface to retain it. Such simple collars can not be used for mounting components that include structural elements which interfere with installation of a collar from the back side. Accordingly, partial collars or keyed collars with a partial overlapping surface have been used to provide a rotatable mounting structure around a flange if they are to be installed from the front, i.e., mating surface side, of a component. However such partial collars, two piece bifurcated collars, and slotted collars are problematic, for example, because they may not provide mounting integrity in all orientations, they may easily fall off an associated plumbing or heating component during shipping or handling, and they may be difficult to hold in place during mounting of the component.

### SUMMARY OF THE INVENTION

Illustrative embodiments of the present invention provide a rotatable flange that can be installed over the front-mating surface of a plumbing or heating component, that provide mounting integrity through 360 degrees of rotation, and that can not fall off the component over the front surface after installation.

The rotatable flange apparatus includes a flange portion, a rotatable mounting plate and a retaining ring. The retaining ring fits inside grooves on the outer edge of the flange portion and on the inner edge of the mounting plate to keep the mounting plate attached to the flange portion. The flange portion can be easily assembled to the rotatable mounting plate and can be removed from the rotatable mounting plate in only one direction. The retaining ring is compressed slightly by the flange portion as the rotatable mounting plate is installed to the flange portion over its front side and snaps back out into the mounting plate groove to complete the assembly and retain the mounting plate to the flange portion.

In some embodiments the rotatable flange apparatus may be integrally or monolithically formed with a plumbing component. In one embodiment the rotatable flange apparatus may be integrally formed with a body portion of a Y-strainer. Thus, allowing the Y-strainer to be interconnected to another component via the rotatable flange apparatus, and for the Y-strainer to be oriented at virtually any angle in a 360 degree rotation.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a perspective view of a rotatable flange apparatus according to an illustrative embodiment of the invention;

FIG. 2 is a cross section view of a flange portion of a rotatable flange apparatus according to an illustrative embodiment of the invention;

FIGS. 3A and 3B are a cross sectional view and a top view of a retaining ring according to an illustrative embodiment of the invention;

FIG. 4 is a cross section view of a rotating ring according to an illustrative embodiment of the invention;

FIG. 5 is a cross section view of an assembled rotatable flange apparatus according to an illustrative embodiment of the invention; and

FIG. 6 is a cross section view of a Y-strainer including a rotatable flange apparatus according to an illustrative embodiment of the invention.

### DETAILED DESCRIPTION

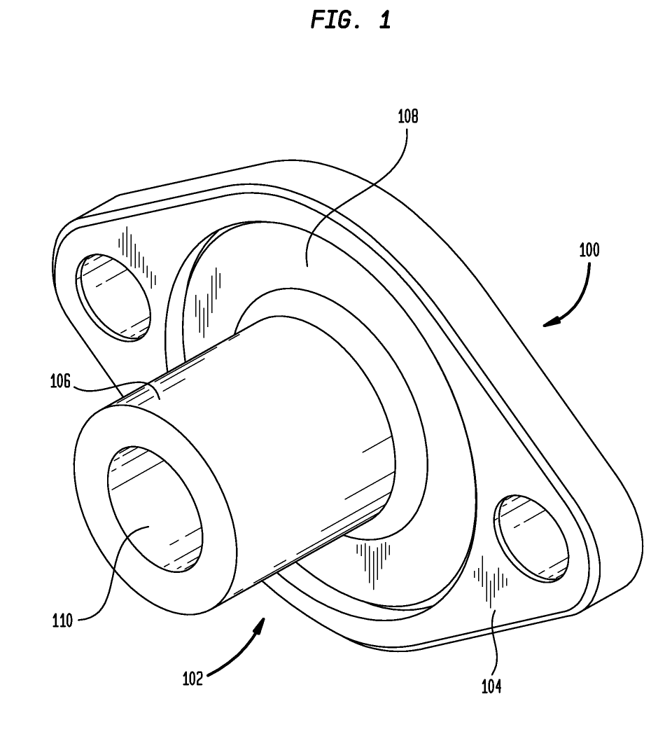

A rotatable flange apparatus according to an illustrative embodiment of the invention is described with reference to the perspective view shown in FIG. 1. The rotatable flange apparatus 100 includes a flange portion 102, a rotatable mounting plate 104 and a retaining ring (not shown). The flange portion 102 includes a neck portion 106, a face portion 108 extending from the flange portion and a path such as a fluid flow path 110 extending through the neck portion 106 and the face portion 108.

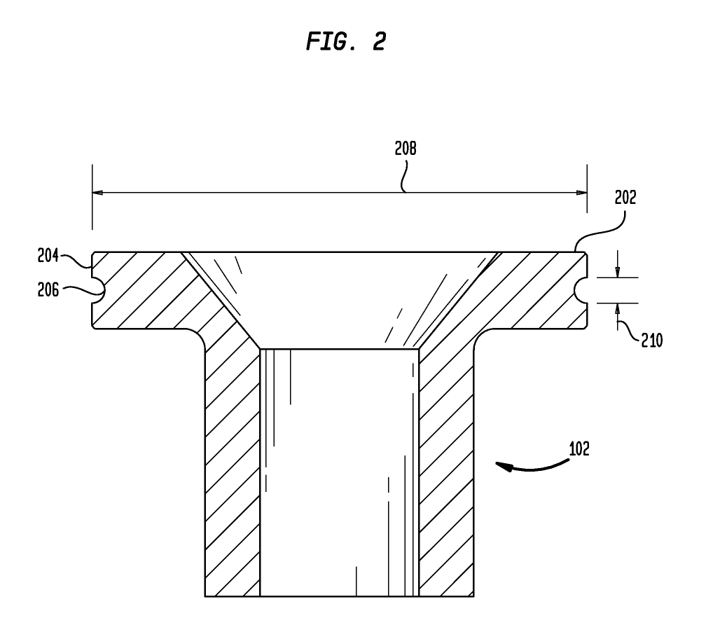

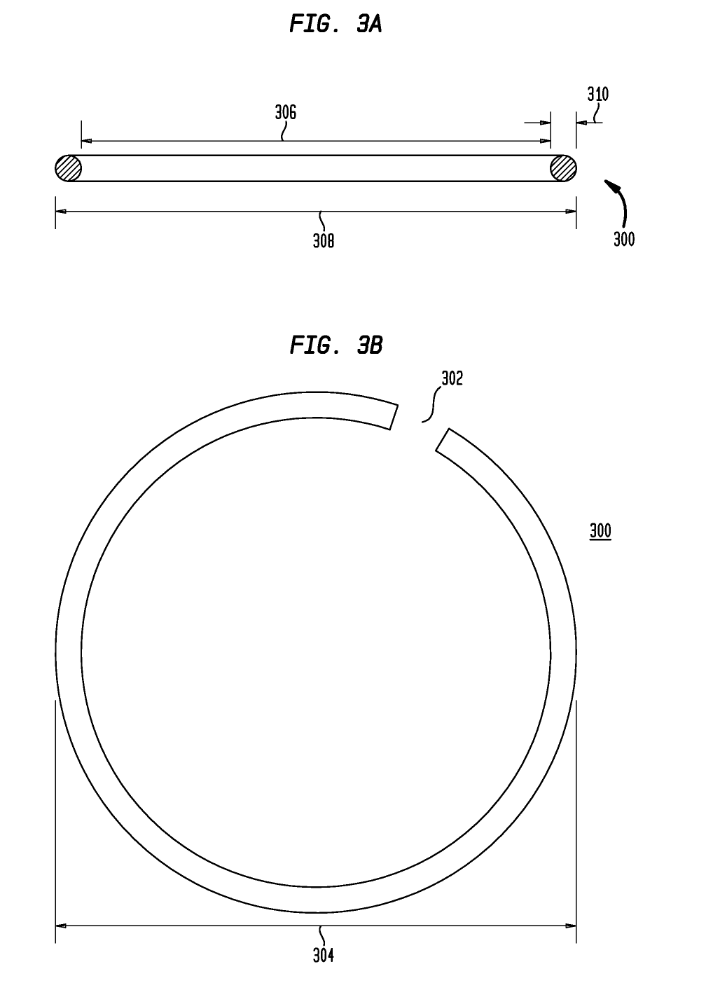

A cross sectional view of the flange portion according to an illustrative embodiment of the invention is described with reference to FIG. 2. The flange portion 102 includes a sealing surface 202, an outside edge 204 and a ring groove 206 in the outside edge 204. A retaining ring 300, as shown in FIGS. 3A and 3B is configured to be disposed in the ring groove 206. Illustratively, the ring groove 206 has a semi-circular cross sectional shape and a cross sectional diameter 210 corresponding to a cross sectional diameter 310 (FIG. 3) of the retaining ring 300 (FIG. 3) to provide a slip fit between the retaining ring 300 (FIG. 3) and the ring groove 206.

In the illustrative embodiment of FIG. 3, the retaining ring 300 is formed from a spring material and includes a ring gap 302. The ring gap 302 allows deformation of the retaining ring 300 in opposition to a spring force of the retaining ring 300. The retaining ring 300 can be deformed to a compressed outside dimension 304 of the retaining ring. In an illustrative embodiment, the retaining ring 300 deformation may include extension to an extended inside dimension of the retaining ring 300 for installation to the groove 206 (FIG. 2).

In the illustrative embodiment, the retaining ring has an inside diameter 306 less than a diameter 208 of the face portion 200. In the illustrative embodiment, the retaining ring has an outside diameter 308 greater than the diameter 208 of the face portion 200.

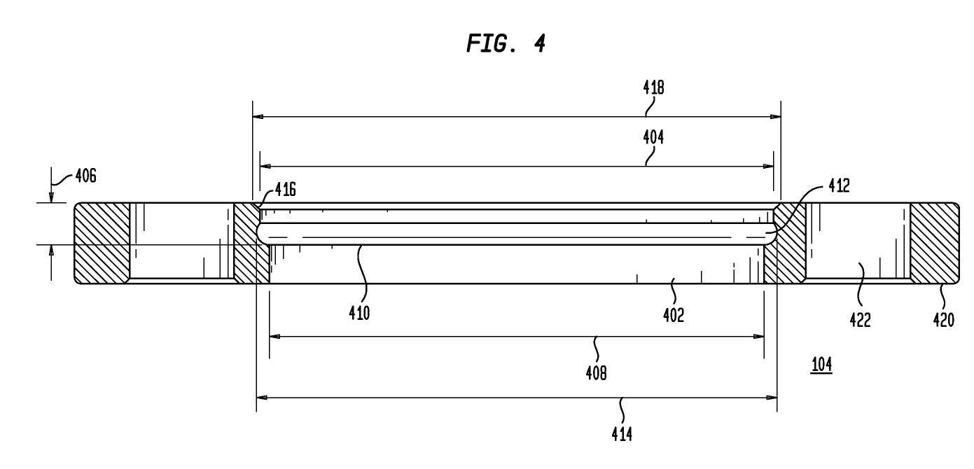

The rotatable mounting plate 104 in the illustrative embodiment is illustrated in a cross sectional view in FIG. 4. The mounting plate 104 includes a hole 402 for accepting and retaining the face portion 108 (FIG. 1) of the flange portion 102 (FIG. 1). The hole 402 has a first diameter 404 greater than the compressed outside dimension 304 (FIG. 3B) of the retaining ring 300 (FIGS. 3A, 3B) to a first depth 406, and a second diameter less than said ring outside diameter beyond said first depth to form a stop 410 at the first depth 406.

The stop 410 prevents the face portion 108 (FIG. 1) from passing through the hole 402 when the retaining ring 300 (FIGS. 3A, 3B) is installed in the ring groove 206 (FIG. 2). In the illustrative embodiment, the stop 410 allows the face portion 108 (FIG. 1) to pass through the hole 402 when the retaining ring 300 (FIGS. 3A, 3B) is not installed in the ring groove 206 (FIG. 2). Illustratively, the stop 410 can be formed as a first annular groove 412 in the hole 402 at the first depth 406 in which the first annular groove 412 has a diameter 414 greater than the first diameter 404 of the hole 402.

Illustratively, the hole 402 can have a lead-in chamfer 416 extending on a front surface of the mounting plate 104 to the first diameter 404 of the hole. The chamfer 416 illustratively has a diameter 418 at the front surface 420 greater than the outside diameter 308 (FIG. 3A) of the retaining ring 300 (FIG. 3A, 3B)

In the illustrative embodiment, the rotatable mounting plate 104 includes at least one fastener hole 422 extending there-through. A rotatable mounting plate 104 according to an illustrative embodiment may alternatively or additionally include at least one fastener stud or other fastener element extending therefrom (not shown) for mating with a corresponding mounting fastener in a plumbing interface, for example.

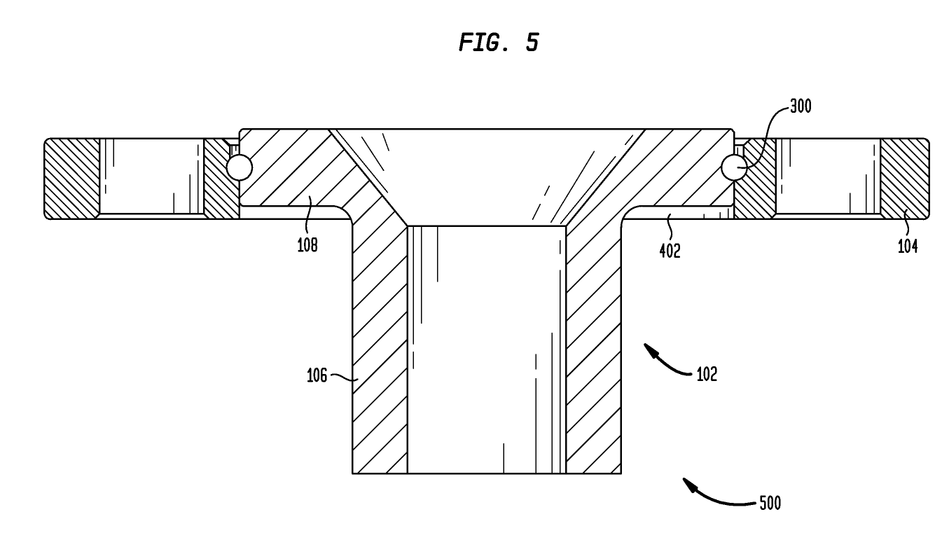

In illustrative embodiments of the invention, the retaining ring 300 (FIGS. 3A, 3B) fits inside the grooves 206 (FIG. 2) and 412 (FIG. 4) to keep the mounting plate 104 (FIG. 1) attached to the flange portion 102. Referring to FIG. 5, the flange portion 102 can be easily assembled to the rotatable mounting plate 104 and can be removed from the rotatable mounting plate 104 in only one direction. The retaining ring 300 is compressed slightly by the flange portion 104 as the flange portion 102 is installed to the rotatable mounting plate 104 and snaps back out into the first annular groove 412 (FIG. 4) to complete the assembly.

A method for forming a plumbing interface with a rotatable flange according to an illustrative embodiment of the invention is described with reference to FIG. 5 which includes a cross sectional view of an assembled flange assembly 500. The method includes installing a rotatable mounting plate 104 over a flange portion 102. The rotatable mounting plate 104 has a hole 402 to accept the flange portion. The rotatable mounting plate 104 also includes at least one interference portion, such as retaining ring 300 preventing the flange portion 102 from passing completely through the hole 402. The illustrative method may also include the step of installing the interference portion between said flange portion 102 and the rotatable mounting plate 104 before installing the rotatable mounting plate 104 over said flange portion 102.

The illustrative method for forming a plumbing interface according to the present invention may also include the steps of aligning mounting elements, such as holes and or studs, for example, in the mounting plate with corresponding mounting elements in a plumbing interface and rotating the flange portion to a selected orientation. A face of the flange portion is then located against a mating face of the plumbing interface. Fasteners are installed to the mounting elements to secure the mounting plate to the plumbing interface so that the mounting plate retains the flange portion against the plumbing interface.

The rotatable flange portion may be assembled with or monolithically formed with other plumbing components. For example, in an illustrative embodiment, at least one valve body (not shown) is in communication with a neck portion and monolithically formed with the neck portion. The valve body may include portions preventing the rotatable mounting plate from fitting over the valve body, thereby requiring assembly of the rotatable mounting plate over the face portion.

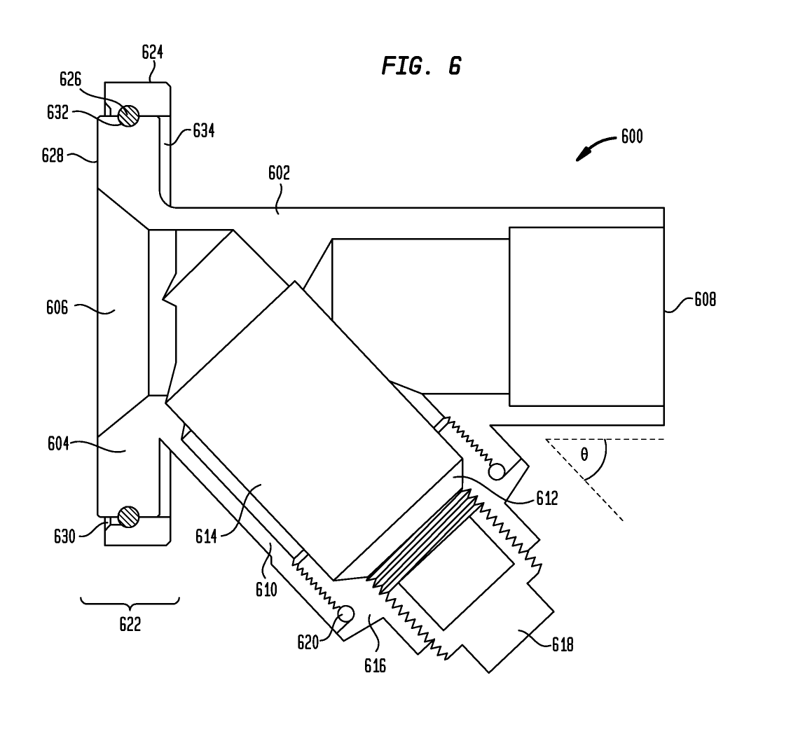

A rotatable flange apparatus integrally or monolithically formed with a plumbing component is described with reference to FIG. 6, which illustrates a cross sectional view of a Y-strainer having a rotatable flange integrally formed therewith. A Y-strainer is typically used for the purpose of removing particulates, dirt, and other unwanted material from a process or fluid stream. The Y-strainer generally includes a body having an inlet, an outlet, and a purge which is positioned at an acute angle from the linear plane of the outlet. The Y-strainer typically collects the particulates, dirt, and other unwanted material on an interior of a screen located in the flow path and extending to the purge. The particulates, dirt, and other unwanted material may then be purged from the screen by removing the screen or allowing the process or fluid stream to carry the particulates, dirt, and other unwanted material out through a purge or strainer outlet.

In the illustrative embodiment of FIG. 6, the Y-strainer 600, includes a body portion 602 and a flange portion 604 monolithically formed with the body portion 602. The body portion 602 defines a fluid flow path connecting a fluid flow inlet 606, a fluid flow outlet 608, and a purge or strainer outlet 612 in an angular branch 610. The fluid flow inlet 606 runs through the flange portion 604, which is integrally connected to the body portion 602. The fluid flow outlet 608 is connected to the fluid flow inlet 606 through the fluid flow path within the body portion 602. The fluid flow outlet 608 may be connected to additional components, such as plumbing components.

The angular branch 610 may be positioned at an acute angle θ from the linear plane of the fluid flow outlet 608, resembling a “Y” shape. The angular branch 610 includes the purge or strainer outlet 612 which is in fluid communication with the fluid flow path between the fluid flow inlet 606 and outlet 608. The angular branch 610 includes a screen 614 within the fluid flow path that connects the purge or strainer outlet 612 to the flow path between the fluid flow inlet 606 and outlet 608. A portion of the screen 614 is positioned directly in the flow path connecting the fluid flow inlet 606 and outlet 608. Thus, fluid enters the Y-strainer 600 at the fluid flow inlet 606 and flows through the interior of the screen 614 to the exterior of the screen 614 and exits through the fluid flow outlet 608. The screen 614 acts to filter particulates, dirt, and other unwanted material out of the fluid stream and retain the particulates, dirt, and other unwanted material on the interior of the screen 614. The screen 614 may be a mesh wire screen, or other mesh material capable of filtering out the particulates, dirt, and other unwanted material. The screen 614 may be any of various shapes including but not limited to cylindrical, rectangular, circular, square, and the like. The screen 614 may cylindrical in shape and has an inner diameter and outer diameter. The screen 614 may have openings having a size of about 0.001 inches to 1 inch. In one embodiment, for example, the screen 614 may have openings of about 0.001 inches to 0.1 inches.

To prevent the fluid stream from exiting the purge or strainer outlet 612 of the angular branch 610, a cover 616 and/or a plug 618 may be threaded onto the purge 612. The cover 616 may have a threaded aperture having an inner diameter less than the outer diameter of the screen 614, to prevent the screen from being removed through the threaded aperture. The plug 618 may be threaded into the threaded aperture of the cover 616. Thus, to purge the screen 614 of particulates, dirt, and other unwanted material the plug 618 may be removed and the screen may be purged while preventing the screen from being removed. The screen 614 may be also removed and replaced or cleaned separately by removing the cover 616. Alternatively, a blow-off valve, such as a ball valve, gate valve, globe valve, and the like may be threaded onto or integrated into the purge 612 for purging the screen of particulates, dirt, and other unwanted material. Additionally, a gasket 620 may be placed in between the cover 616 and the outlet of the angular branch 610 to provide a fluid impermeable seal. The gasket 620 may be any of various types of gasket such as but not limited to an o-ring, fiber washer, paper gasket, or the like. The gasket 620 may be made from any material such as but not limited to a paper, rubber, silicone, metal, cork, felt, neoprene, nitrile rubber, fiberglass, a plastic polymer, and the like.

As shown in FIG. 6, the Y-strainer 600 has a rotatable flange portion 622 (the embodiments of which are described in detail above) integrally or monolithically formed therewith, at the inlet 606 side of the Y-strainer 600 to provide a mating surface for interconnection of the Y-strainer to additional components. However, it is contemplated that the rotatable flange portion 622 may be integrally or monolithically formed at any inlet or outlet where a mating surface is need for interconnection of components and coupled to the Y-strainer.

The rotatable flange portion 622 includes a flange portion 604, a rotatable mounting plate 624, a retaining ring 626, and at least one fastener hole 422 (as shown in FIGS. 4 and 5). In this embodiment, the flange portion 604, of the Y-strainer is integrally formed with the body portion 602 of the Y-strainer 600. The flange portion 604 includes a face portion 628, an outside edge 630 and a ring groove 632 in the outside edge 630. The fluid flow inlet 606 extends through the face portion 628 and body portion 602 of the Y-strainer 600. The retaining ring 626 is configured to be disposed in the ring groove 632. In the illustrative embodiment, the retaining ring has an inside diameter less than a diameter of the face portion 628. In the illustrative embodiment, the retaining ring has an outside diameter greater than the diameter of the face portion 628. The retaining ring 626 may be substantially the same retaining ring 300 as shown and described above in accordance with FIGS. 3A and 3B.

The rotatable mounting plate 624 is disposed on the body portion 602 capable of being placed in communication with the flange portion 604. The rotatable mounting plate 624 includes a hole 634 for accepting and retaining the face portion 628 of the flange portion 604. The hole 634 may be the hole 402 as shown and described above in accordance with FIG. 4, including the stop 410, grooves 412, and optionally the chamfer 416. The retaining ring 626 fits inside the grooves 632 and the grooves 412 (as shown in FIG. 4) on the mounting plate 624 to keep the mounting plate 624 attached to the flange portion 604. The flange portion 604 can be easily assembled to the rotatable mounting plate 624 and can be removed from the rotatable mounting plate 624 in only one direction. The retaining ring 626 is compressed slightly by the flange portion 604 as the flange portion 604 is installed to the rotatable mounting plate 624 and snaps back out into the first annular groove 412 (as shown in FIG. 4) to complete the assembly. The angular branch 610 may prevent the rotatable mounting plate 624 from being removed from the Y-strainer. The rotatable flange permits the Y-strainer to be mounted loosely and rotated 360 degrees for tightening in a preferred orientation.

Although the various embodiments of the invention are described herein in terms of a plumbing interface, it should be understood by persons having ordinary skill in the art that the present invention includes virtually any type of fluid system interface, such as heating system interfaces, cooling system interfaces, exhaust system interfaces, gas transfer interfaces and the like.

Further, it should be appreciated that although the flange portion embodiments described herein are described as including a fluid flow path, the flange portion could be used as an interconnect wherein the path is not for fluid flow but instead is a passage such as for wire, cable conduct or the like.

While the invention has been described and illustrated in connection with preferred embodiments, many variations and modifications will be evident to those skilled in the art and may be made without departing from the spirit and scope of the invention. The invention is thus not to be limited to the precise details of methodology or construction set forth above as such variations and modification are intended to be included within the scope of the invention.

What is claimed is:

1. A plumbing component integrated with a rotatable flange apparatus, comprising:
a body portion including an angular branch and a flange portion monolithically formed with said body portion and extending from said body portion, and a fluid flow path extending through said body portion, said angular branch, and said flange portion;
said fluid flow path having an inlet through said flange portion, an outlet opposite said inlet through said body portion, and a purge through said angular branch of said body portion;
said flange portion having a face portion, a sealing surface, an outside edge and a ring groove in said outside edge;
a screen disposed within said angular branch and extending from said purge through said fluid flow path and into said fluid flow path connecting said inlet with said outlet;
a retaining ring disposable in said ring groove; and
said retaining ring having an inside diameter less than a diameter of said face portion and having an outside diameter greater than said diameter of said face portion;
a rotatable mounting plate disposed around said body portion including a hole for accepting and retaining said flange portion;
said hole having a first diameter greater than said compressed outside dimension to a first depth and a second diameter less than said ring outside diameter beyond said first depth to form a stop at said first depth, said stop preventing said face portion from passing through said hole when said ring is installed in said ring groove and allowing said face portion to pass through said hole when said ring is not installed in said ring groove.

2. The apparatus of claim 1, wherein said stop comprises a first annular groove in said hole at said first depth, said first annular groove having a diameter greater than said first diameter.

3. The apparatus of claim 1, wherein said ring groove has a semi-circular cross sectional shape and a cross sectional diameter corresponding to a cross sectional diameter of said retaining ring and providing a slip fit between said retaining ring and said ring groove.

4. The apparatus of claim 1, wherein said hole includes a lead-in chamfer from a front surface of said rotatable mounting plate to said first diameter, said chamfer having a diameter at said front surface greater than said outside diameter of said retaining ring.

5. The apparatus of claim 1, wherein said rotatable mounting plate includes at least one fastener hole extending there-through.

6. The apparatus of claim 1, wherein said rotatable mounting plate includes at least one fastener stud extending there-from.

7. The apparatus of claim 1, wherein said retaining ring is formed from a spring material and includes a ring gap allowing deformation of said ring in opposition to a spring force of said retaining ring, said deformation including compression to a compressed outside dimension of said retaining ring.

8. The apparatus of claim 7, wherein said deformation includes extension to an extended inside dimension of said retaining ring for installation to said groove.

9. The apparatus of claim 1, wherein said angular branch of said body portion is positioned at an acute angle relative to the linear plane of said outlet.

10. The apparatus of claim 1, wherein said angular branch of said body portion prevents said rotatable mounting plate from fitting over said body portion and thereby requires assembly of said rotatable mounting plate over said face portion.

11. The apparatus of claim 1, wherein said angular branch further includes a valve operably connected to said purge.

12. A method for forming a plumbing interface with a rotatable flange, comprising:
providing a Y-strainer having an integrated flange portion and a rotatable mounting plate disposed around a body portion of said Y-strainer; and
installing said rotatable mounting plate over said flange portion, said rotatable mounting plate having a hole to accept said flange portion and at least one interference portion preventing said flange portion from passing completely through said hole.

13. The method of claim 12, comprising:
installing said interference portion between said flange portion and said rotatable mounting plate before installing said rotatable mounting plate over said flange portion.

14. The method of claim 12, comprising:
aligning mounting elements in said mounting plate with corresponding mounting elements in a plumbing interface;
rotating said flange portion to a selected orientation;
locating a face of said flange portion against a mating face of said plumbing interface;
installing fasteners to said mounting elements to secure said mounting plate to said plumbing interface so that said mounting plate retains said flange portion against said plumbing interface.

15. A plumbing component integrated with a rotatable flange apparatus, comprising:
a body portion including an angular branch and a flange portion monolithically formed with said body portion and extending from said body portion, and a fluid flow path extending through said body portion, said angular branch, and said flange portion;
said fluid flow path having an inlet through said flange portion, an outlet opposite said inlet through said body portion, and a purge through said angular branch of said body portion;
said flange portion having a face portion, a sealing surface, an outside edge and a ring groove in said outside edge;
said angular branch extends from said body portion at an acute angle relative to the linear plane of said outlet;
a screen having an outer diameter disposed within said angular branch and extending from said purge through said fluid flow path and into said fluid flow path connecting said inlet with said outlet;
a cover threadably attached to said purge including a threaded aperture having an inner diameter less than said outer diameter of said screen;
a plug threadably attached to said threaded aperture of said cover;
a retaining ring disposable in said ring groove; and
said retaining ring having an outside diameter greater than said diameter of said face portion;
a rotatable mounting plate disposed around said body portion including a hole for accepting and retaining said flange portion;
said hole having a first diameter greater than said compressed outside dimension to a first depth and a second diameter less than said ring outside diameter beyond said first depth to form a stop at said first depth, said stop preventing said face portion from passing through said hole when said ring is installed in said ring groove and allowing said face portion to pass through said hole when said ring is not installed in said ring groove.

16. The apparatus of claim 15, wherein said retaining ring is formed from a spring material and includes a ring gap allowing deformation of said ring in opposition to a spring force of said retaining ring, said deformation including compression to a compressed outside dimension of said retaining ring.

17. The apparatus of claim 16, wherein said deformation includes extension to an extended inside dimension of said retaining ring for installation to said groove.

18. The apparatus of claim 17, wherein said angular branch of said body portion prevents said rotatable mounting plate from fitting over said body portion and thereby requires assembly of said rotatable mounting plate over said face portion.

19. The apparatus of claim 18, wherein said rotatable mounting plate includes at least one fastener hole extending there-through.

20. The apparatus of claim 18, wherein said rotatable mounting plate includes at least one fastener stud extending there-from.
